(19) United States
(12) Patent Application Publication
(10) Pub. No.: US 2007/0229520 A1
(43) Pub. Date: Oct. 4, 2007

(54) Buffered Paint Systems

(75) Inventors: Jeffrey S. Miller, Woodinville, WA (US); Jonathan J. McGee, Seattle, WA (US); Laurent Mouton, Bellevue, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: MICROSOFT CORPORATION, Redmond, WA (US)

(21) Appl. No.: 11/278,322

(22) Filed: Mar. 31, 2006

(51) Int. Cl. G06T 1/60

(52) U.S. Cl. 345/530

(57) ABSTRACT

Methods and systems for allocating a buffer from a buffer pool and for performing buffered rendering with animated transitions are described. An illustrative computer-implemented method includes steps of receiving, from a thread, a request for a buffer from a buffer pool associated with the thread, determining whether a first pre-existing buffer from the buffer pool associated with the thread can be allocated to the thread, and upon determining that the first pre-existing buffer can be allocated, allocating the first pre-existing buffer to the thread. Another illustrative computer-implemented method includes steps of receiving a request to render to a display, initiating a function to obtain a buffer for rendering to the display, receiving transition parameter data specifying how content of the buffer transitions to the display over a period of time, and rendering the content of the buffer in accordance to the transition parameter data.

### BACKGROUND

Human interaction with computers has continuously increased in occurrence beyond the work environment. Today, people use computers more than ever before. Specifically, computers are utilized in cell phones, home computers, security systems, television satellite/cable boxes, video game systems, stereo devices, and automobiles among other devices. In addition, the use of display monitors and other rendering devices has helped to provide an easy to use environment for individuals.

Rendering a user interface to a display screen is a common task that most application programs must perform. Double-buffering is an example of a rendering technique. Double-buffering is used to achieve high-quality rendering by redirecting painting to an off-screen buffer and then copying its contents to a display screen. However, double-buffering in an application program requires long, complex code to achieve only basic buffering functionality. Functionality such as animated transitions requires custom code in each application program. All of this additional custom code inevitably results in duplicated work and leads to the potential for costly code errors. In addition, performance suffers since buffered painting requires additional memory resources and processing resources for memory allocation and deallocation.

With the advances in operating systems, buffered painting has become an even greater challenge. Windows® Vista™, Microsoft® Corporation of Redmond, Wash. U.S.A., introduces translucent appearance user interfaces, which are rendered to a display screen using varying amounts of translucency, giving a glass-like effect. However, properly rendering an image onto a glass appearance surface can be difficult. Unlike in the past, user interfaces are drawn in full 32-bit color, including an alpha channel. With traditional buffering techniques, low-level pixel manipulation is required to render an image on a glass appearance surface properly, since existing drawing APIs are not designed to support 32-bit rendering.

### BRIEF SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present invention are directed to a method and system for allocating a buffer from a buffer pool that includes a plurality of existing buffers. A request for a buffer from a buffer pool associated with a thread is received and a determination is made as to whether a buffer from the buffer pool associated with the thread can be allocated to the thread. Upon determining that one of the buffers in the buffer pool can be allocated, that buffer is allocated to the thread. The request may be for a specific type of buffer or size of buffer. Another aspect of the present invention provides for computing the size of each buffer in a buffer pool and computing a difference in size between the computed size and the requested buffer size. Larger buffers in the buffer pool may be allocated by minimizing the buffer size, smaller buffers in the buffer pool may be allocated by expanding the buffer size, and/or new buffers may be created to accommodate the requested buffer size. A threshold limit may be set in order to determine whether a new buffer is created.

Another illustrative aspect is directed to methods and systems for performing buffered rendering with animated transitions. An application programming interface (API) function corresponding to a request to render to a display is received and a function to obtain a buffer for rendering to the display is initiated. Transition parameter data specifying how content of the buffer transitions to the display over a period of time is received and the content of the buffer is rendered in accordance to the transition parameter data. New transition parameter data may be received and the contents of the buffer may be rendered by the new transition parameter data.

### BRIEF DESCRIPTION OF THE DRAWINGS

A more complete understanding of aspects of the present invention and the advantages thereof may be acquired by referring to the following description in consideration of the accompanying drawings, in which like reference numbers indicate like features, and wherein:

FIG. 1A illustrates a schematic diagram of a general-purpose digital computing environment in which certain aspects of the present invention may be implemented.

FIGS. 1B through 1M show a general-purpose computer environment supporting one or more aspects of the present invention.

FIG. 2 illustrates a method for implementing a ‘Begin/End’ mechanism according to an illustrative aspect of the invention.

FIG. 3 illustrates a method for implementing a thread-wide buffer pooling mechanism according to an illustrative aspect of the invention.

FIG. 4 illustrates a method for managing a thread-wide buffer pooling mechanism according to an illustrative aspect of the invention.

FIG. 5 illustrates a method for performing buffered rendering with animated transitions according to an illustrative aspect of the invention.

FIG. 6 illustrates a diagram of a class structure regarding the relation between various classes according to an illustrative aspect of the invention.

FIG. 7 illustrates a system state when an API in accordance with at least one aspect of the present invention is in use.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

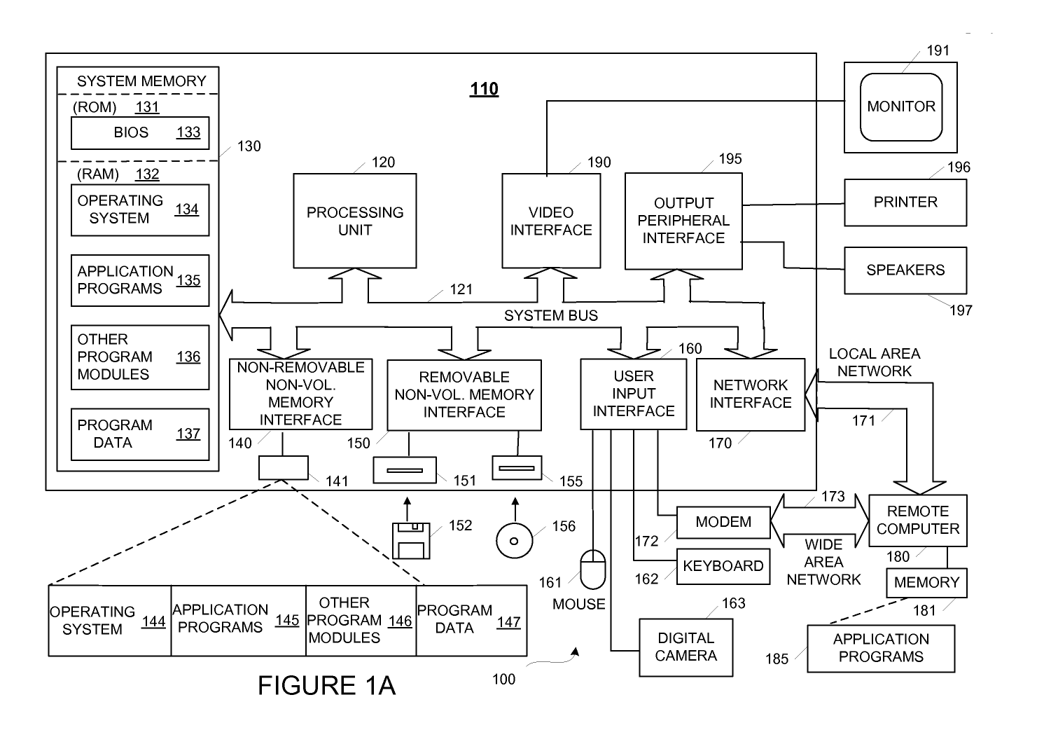

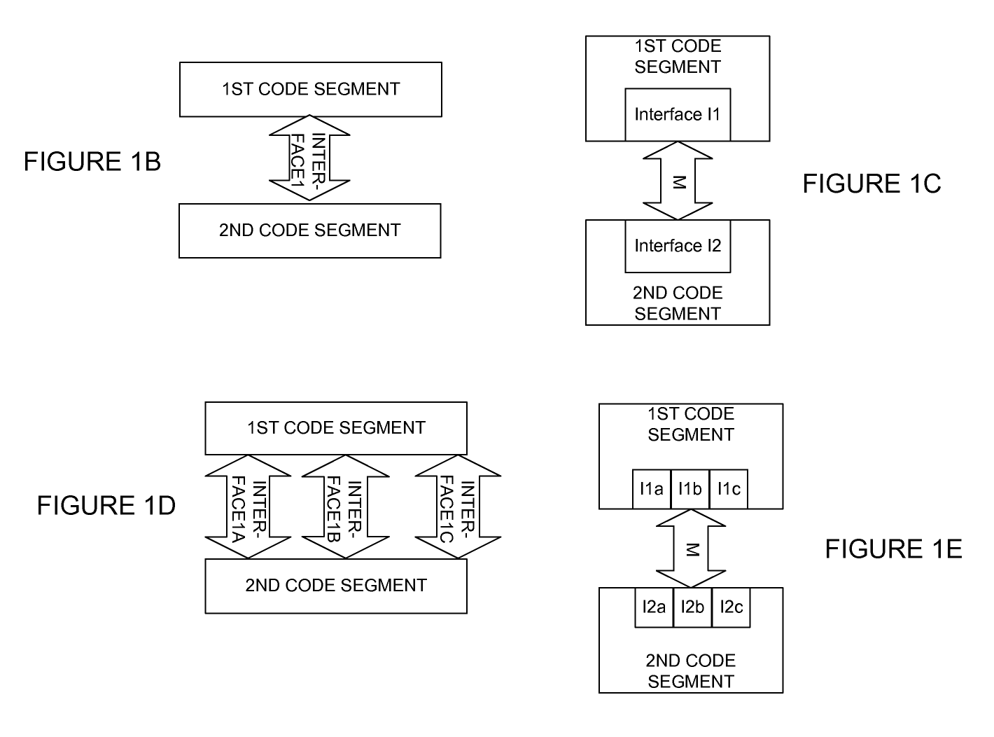

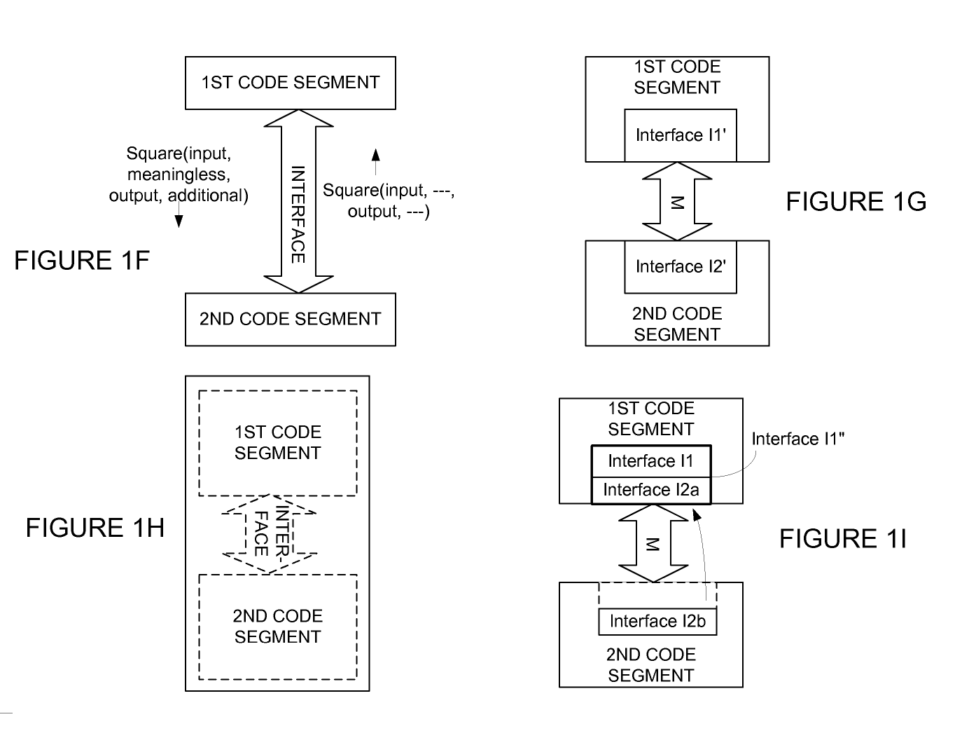

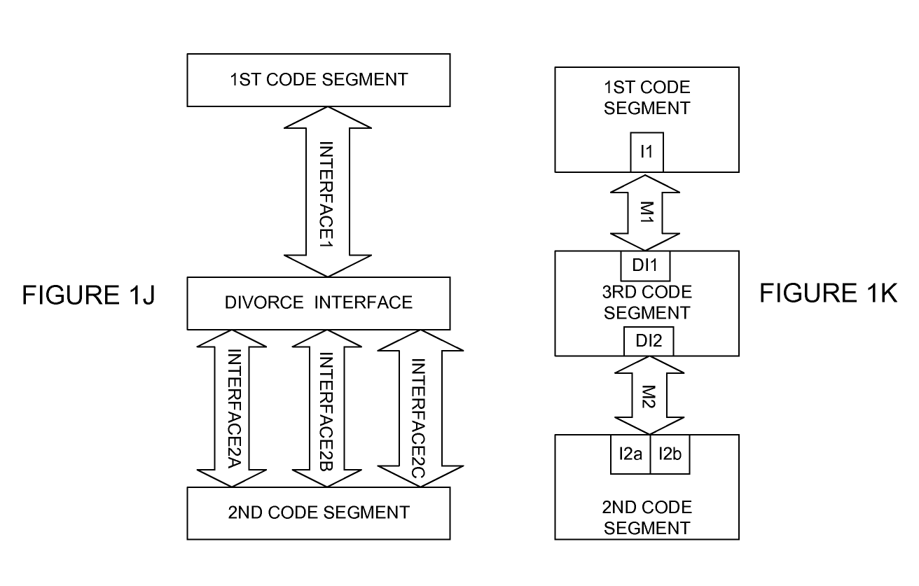

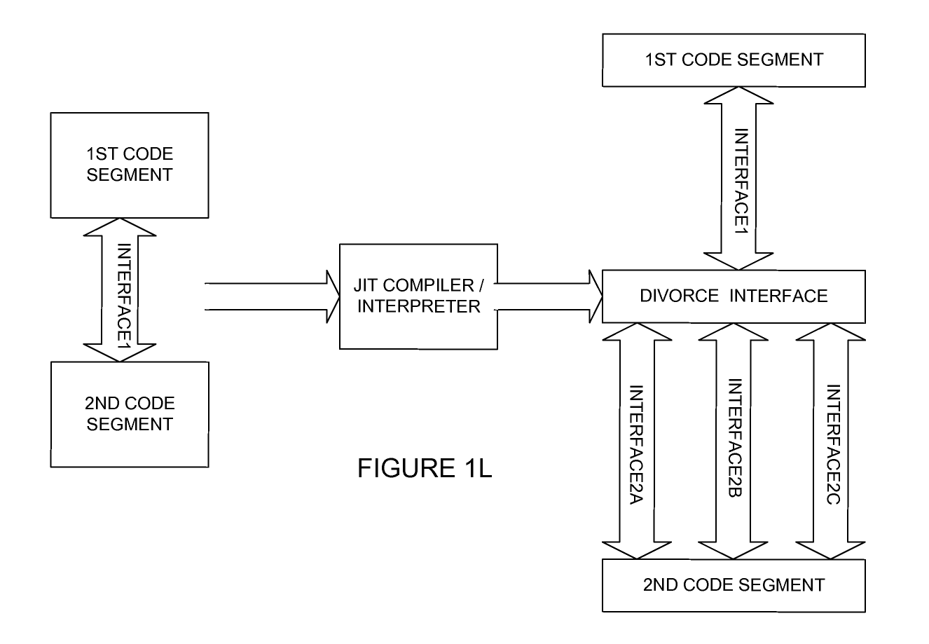

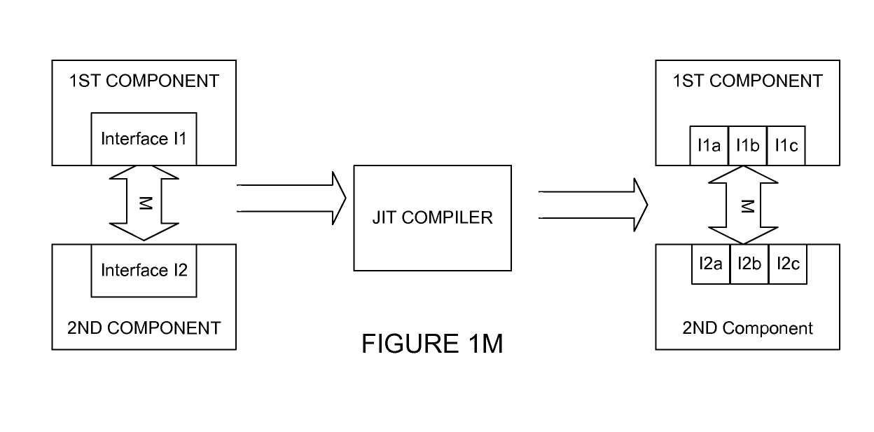

FIG. 1A illustrates an example of a suitable computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1A, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1A illustrates operating system 134, application programs 135, other program modules 136, and program data 137.

The computer 110 may also include other removable/non-removable, volatile/nonvolatile computer storage media. By way of example only, FIG. 1A illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media discussed above and illustrated in FIG. 1A, provide storage of computer readable instructions, data structures, program modules and other data for the computer 110. In FIG. 1A, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a digital camera 163, a keyboard 162, and pointing device 161, commonly referred to as a mouse, trackball or touch pad. Other input devices (not shown) may include a pen, stylus and tablet, microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1A. The logical connections depicted in FIG. 1A include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1A illustrates remote application programs 185 as residing on memory device 181. It will be appreciated that the network connections shown are exemplary and other means of establishing a communications link between the computers may be used.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 1B and 1C, but they nonetheless perform a similar function to accomplish the same overall result. We will now briefly describe some illustrative alternative implementations of a programming interface.

Factoring

A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

Redefinition

In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square (input, precision, output), a call that includes three parameters, input, precision and output, and which is issued from the 1st Code Segment to the 2nd Code Segment. If the middle parameter precision is of no concern in a given scenario, as shown in FIG. 1F, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

Inline Coding

It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 1C performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

Divorce

A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 1C to a new operating system, while providing the same or similar functional result.

Rewriting

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

Aspects of the invention are directed to a new application programming interface (API) that solves the problems of traditional buffering techniques and that provides a new level of convenience and capability to buffered painting. Utilizing aspects of the API, a simple but powerful interface, developers may perform traditional double-buffering techniques using a broad range of buffer formats, may accomplish rich animated transitions by simply adjusting parameters provided to the API, and may transparently reap performance benefits of thread-wide buffer sharing using a buffer pool managed automatically by the API.

Aspects of the present invention may be utilized as part of an application programming interface (API). An API includes software that an application program uses to request and implement specific operations. An API may be a set of standard software interrupts, calls, and data formats for application programs to interact with an operating system. An API in accordance with one or more aspects of the present invention includes an interface using ‘Begin/End’ semantics, a thread-wide buffer pool, a self-optimizing buffer matching algorithm, and animated transition semantics, each of which are described in more detail below.

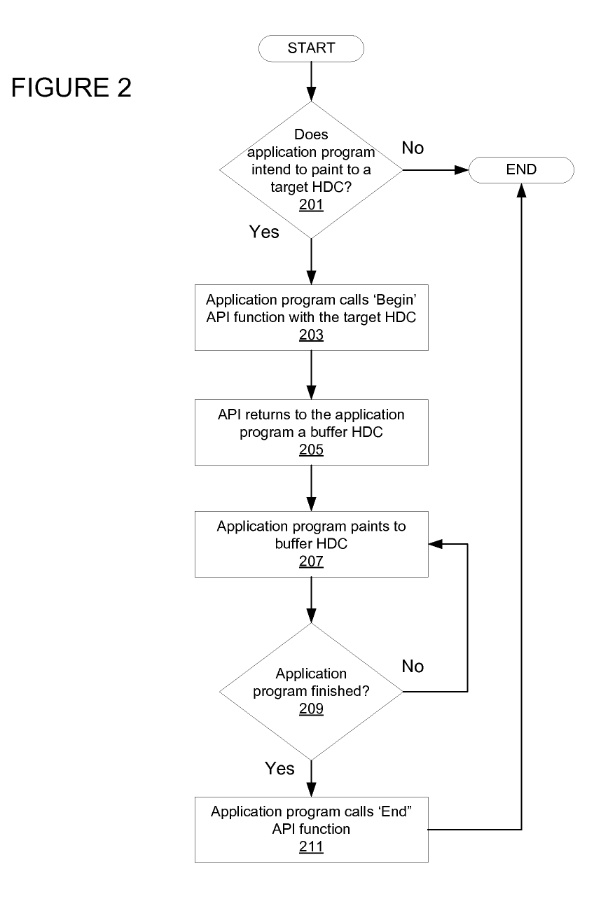

The sequence of steps needed to achieve a correct buffered paint includes, at a minimum, creating a target-compatible buffer, obtaining a handle, such as an opaque object, for rendering to the buffer, painting to the buffer, copying the buffer to the target, and destroying the buffer. In accordance with at least one aspect of the present invention, an API provides a ‘Begin/End’ mechanism for buffered painting. FIG. 2 illustrates a method for implementing a ‘Begin/End’ mechanism.

The process starts at step 201 where a determination is made as to whether an application program intends to paint to a target, specified by a device context handle or HDC. If not, the process ends. Alternatively, in accordance with one or more aspects of the present invention, when the application program does intend to paint to the target, specified by a device context handle or HDC, the application program calls a ‘Begin’ API function with the target HDC at step 203. In response, at step 205 the API returns to the application program a buffer HDC. At step 207, the application program then proceeds to paint to the buffer HDC just as if the application program were painting to the target HDC. The API may automatically handle buffer allocation and setup.

At step 209, a determination is made as to whether the application program is finished. If not, the process returns to step 207. When the application program is finished painting, it calls an ‘End’ API function at step 211 and the process ends. Finally, the API may automatically update the target and perform any necessary buffer destruction automatically. With the ‘Begin/End’ semantics, an API may be integrated into existing code, providing immediate maintainability and performance benefits with minimal effort.

Performance is another motivation behind aspects of the present invention. Allocation and deallocation of buffers, especially 32-bit device-independent bitmaps (DIBs), may be very expensive, both in terms of memory and processor resources. In high-performance interactive applications, rendering may have a significant impact on a user's perception of overall system performance.

It should be understood by those skilled in the art that although the examples provided herein relate to double-buffering, a paint buffer also provides an abstraction to the physical painting surface, allowing applications to create a surface of the pixel format it desires, whether for convenience or compatibility with other software, and then to manipulate the bits directly. This may be independent of performance aspects, applications that need direct access to buffers to do their own pixel processing, or an interface with software render packages. The buffered paint API provides the convenience of application-specified pixel formats while keeping the performance gain.

In other words, whether your application needs a buffer for flicker-free painting, e.g., double-buffering, pixel manipulation, including 32-bit transparency, and/or transition animations, the buffered paint API of the present invention helps.

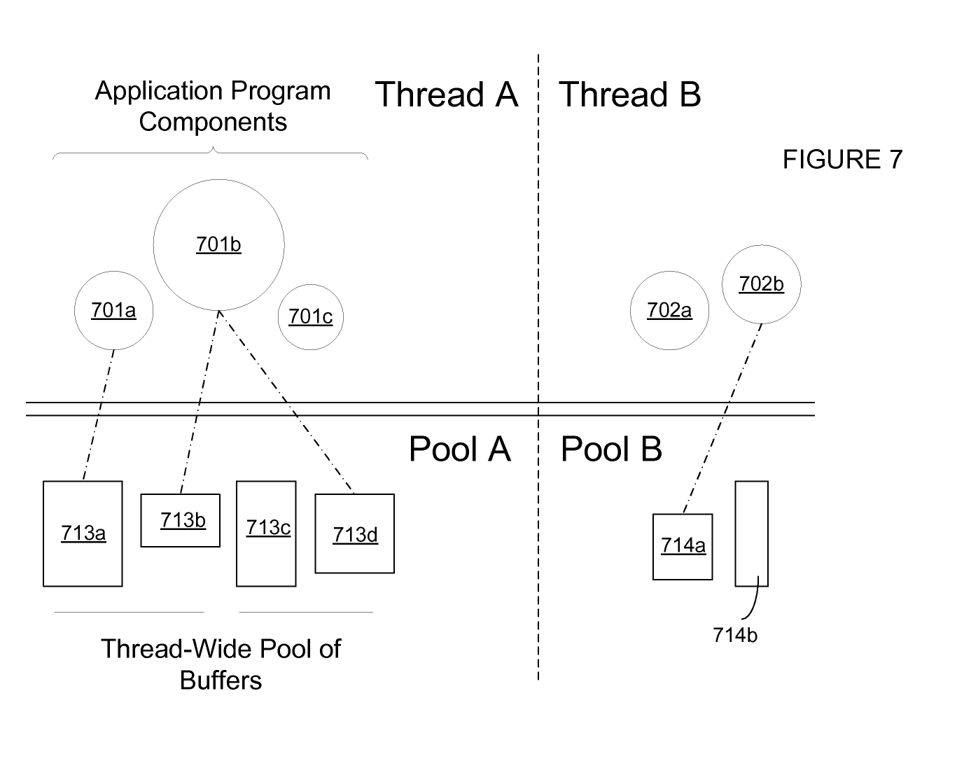

In accordance with at least one other aspect of the present invention, an API provides a thread-wide buffer pool. The API achieves high performance through the use of the thread-wide buffer pooling mechanism. This mechanism may be completely transparent to a user of the API. Each system thread may be associated with a set of buffers, called a thread-wide buffer pool. FIG. 7 illustrates an example of such a thread-wide buffer pool.

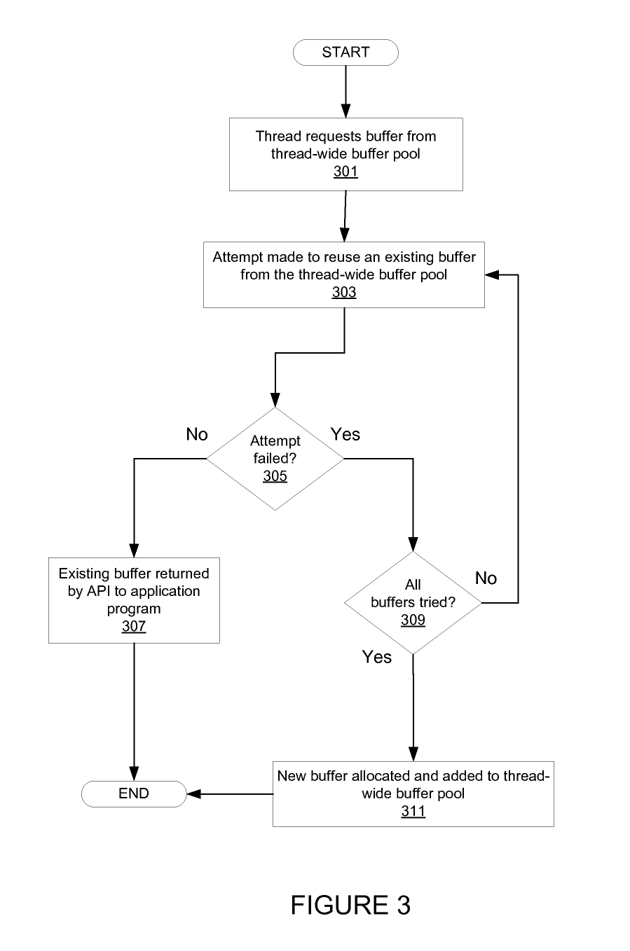

FIG. 3 illustrates a method for implementing a thread-wide buffer pooling mechanism in accordance with at least one aspect of the present invention. The process starts at step 301 when a buffer from a thread-wide buffer pool is requested by a thread. At step 303, an attempt is made to reuse an existing buffer from the thread-wide buffer pool. Proceeding to step 305, a determination is made as to whether the attempt to reuse the existing buffer failed. If not, the process moves to step 307 where the existing buffer is returned by an API to the requesting application program where the buffer is reused. Alternatively, if the attempt fails in step 305, the process moves to step 309.

At step 309, a determination is made as to whether all the existing buffers in the thread-wide buffer pool have been attempted to be reused. If all the existing buffers have not been tried, the process returns to step 303 where another existing buffer in the pool is attempted. If all have been tried at step 309, the process moves to step 311 where a new buffer is allocated and added to the thread-wide buffer pool. The thread-wide buffer pool adapts to the use of the API by the application program, so that eventually all buffer requests may be satisfied by reusing buffers in the thread-wide buffer pool. As a result, expensive buffer allocations and deallocations are avoided, and application performance is significantly enhanced. Unlike other application-specific pooling techniques, the thread-wide buffer pool in accordance with the present invention is shared across the entire thread, so that the various parts of an application program may reuse the same set of buffers, resulting in performance benefits. Buffers may be created or destroyed as necessary.

In accordance with at least one other aspect of the present invention, an API provides a self-optimizing buffer matching algorithm. The thread-wide buffer pooling mechanism used by an API in accordance with aspects of the present invention may utilize techniques for managing pool growth and buffer selection. One need for managing buffers may be to minimize the memory allocated for buffers by each thread, thus increasing system performance as fewer resources are used.

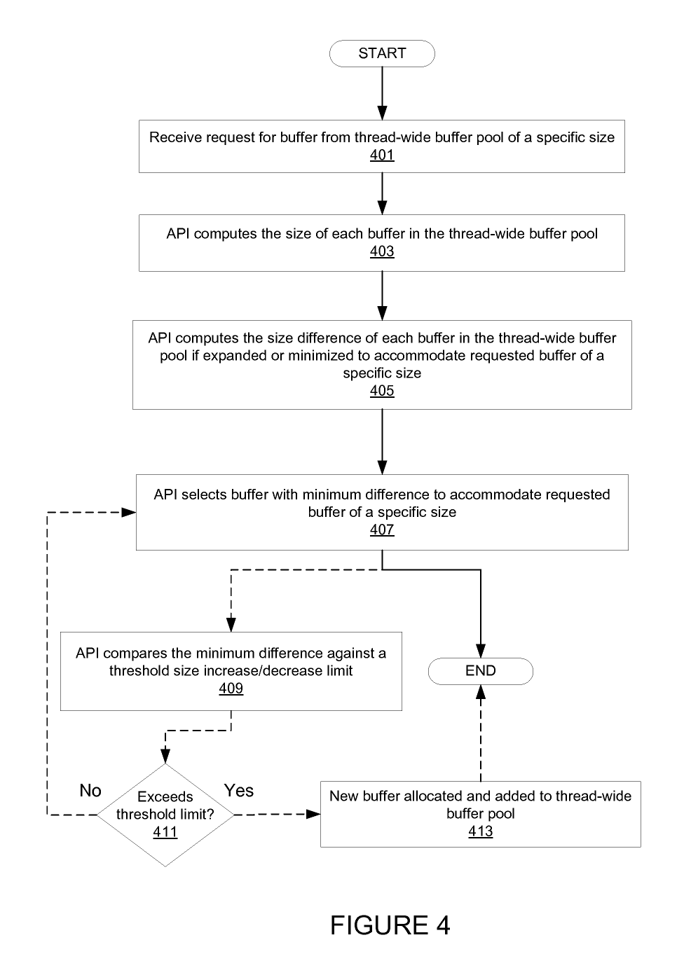

An API in accordance with at least one aspect of the present invention may minimize pool growth by initiating a self-optimizing buffer matching algorithm. In order to increase the performance of the buffer pool, management of which buffers in the pool are used increases. By reusing previously created buffers, processing time and resources are reduced since fewer buffers have to be destroyed and fewer buffers have to be created. FIG. 4 illustrates a method for managing a thread-wide buffer pooling mechanism in accordance with at least one aspect of the present invention.

The process starts at step 401 where a request for a buffer of a specific size is received. Given the request for the buffer, an algorithm associated with an API scans all buffers in the thread-wide buffer pool to select a buffer that will result in minimal memory allocation. At step 403, an algorithm of the API computes the size, such as in total pixels, of each buffer in the thread-wide buffer pool. At step 405, an algorithm of the API computes the size increase of each buffer in the thread-wide buffer pool if the buffer's width and height were expanded to accommodate a larger buffer request than the size of the buffer or computes the size decrease of each buffer in the thread-wide buffer pool if the buffer's width and height were minimized to accommodate a smaller buffer request than the size of the buffer.

Proceeding to step 407, the algorithm selects the buffer for which this difference in size is a minimum amongst the buffers in the thread-wide buffer pool and the process ends. In an optional procession shown in broken lines from step 405, at step 409, the minimum difference may be compared against a threshold size increase/decrease limit. Such a case may occur if the processing resources would be less to create a new buffer rather than expand/minimize and existing buffer. A determination is made at step 411 as to whether the minimum difference exceeds the threshold limit. If not, the process proceeds to step 407. If the minimum difference does exceed the threshold limit in step 411, the process moves to step 413 where a new buffer is allocated in the thread-wide buffer pool and, when no longer used by an application program, becomes available for reuse.

For example, a thread-wide buffer pool may include a first buffer of total pixel size X and a second buffer of total pixel size Z, where Z is larger than X. If a request for a buffer of total pixel size Y is received, where Y is larger than X but smaller than Z, the algorithm of the API computes the size increase needed to have the first buffer of total pixel size X accommodate the request for a buffer of total pixel size Y, and the algorithm computes the size decrease needed to have the second buffer of total pixel size Z accommodate the request for a buffer of total pixel size Y. In this example, it may be determined that the size difference to increase the buffer size of the first buffer is less than the size difference to decrease the buffer size of the second buffer. In such a case, the first buffer may be expanded and allocated by the API to an application program needing the buffer of total pixel size Y. Alternatively, the API may compare the size difference to increase the buffer size of the first buffer against a threshold buffer size increase limit. If the size difference exceeds the threshold limit, the API creates a new buffer of total pixel size Y and allocates that buffer to the application program. That newly created buffer of total pixel size Y is added to the thread-wide buffer pool for future use.

The effect of this algorithm is to minimize the buffer allocations generated by a thread over time. The buffer pool self-optimizes according to the pattern of application buffer usage. Application programs requiring various sizes of buffers and various numbers of buffers simultaneously will achieve greater performance increase with a minimal increase in memory utilization. An API may further allow for the creation and/or destruction of buffers in the thread-wide buffer pool as needed.

In accordance with at least one other aspect of the present invention, an API provides animated transition semantics. Animated transitions allow application programs to achieve visually appealing rendering effects. In accordance with aspects of the present invention, an API provides behavior for performing buffered painting combined with animated transitions. With the interface using ‘Begin/End’ semantics described above for double-buffering, additional transition parameters may be provided to the ‘Begin’ API function. Specifically, these additional transition parameters specify how the contents of the buffer transition to the display screen over time. Thus, an application program may switch from a non-animated transition to an animated transition or one animated transition to another animated transition with minimal effort and code changes and using the same interface.

With animated transitions in effect, the manner in which buffer contents are transferred to a display screen gains increased focus. When a transition to a particular area of a display screen is requested, that particular area may be in one of several states. The particular area may be in a static displayed state or the particular area may be in the process of being updated by a pre-existing animated transition. In the case of the latter, the requested particular area may or may not match with the area being updated by the pre-existing transition. When these areas do match, in accordance with aspects of the present invention, the self-optimizing buffer matching algorithm automatically selects the same buffer used by the pre-existing transition. In this way, the transition may continue with updated buffer contents, resulting in a smooth combination of transitions rather than an abrupt termination of the pre-existing transition.

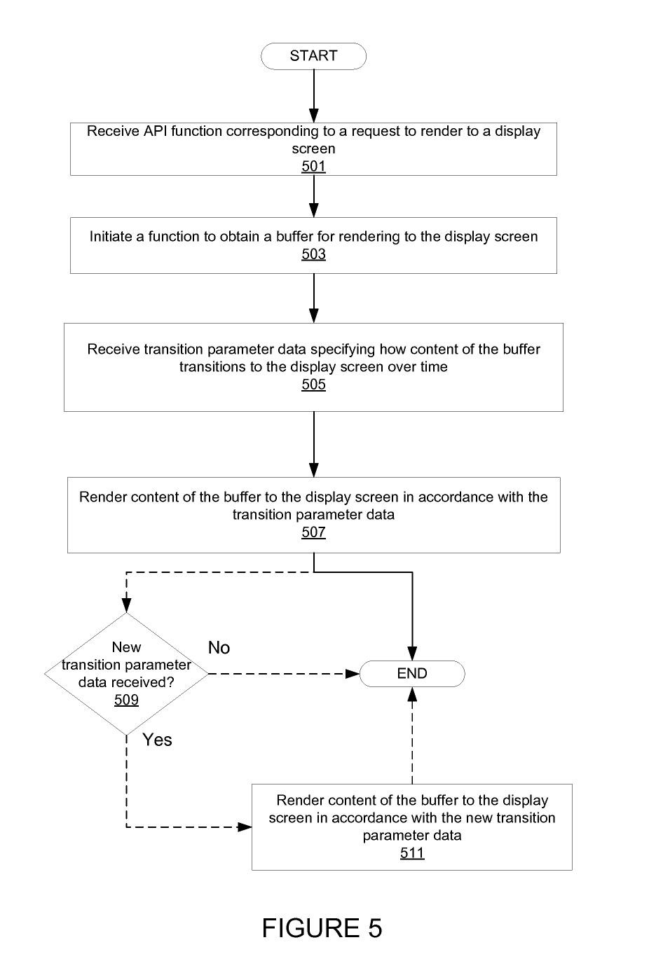

FIG. 5 illustrates a method for performing buffered rendering with animated transitions in accordance with at least one aspect of the present invention. The process starts at step 501 where an API function corresponding to a request to render to a display screen is received. At step 503, a function to obtain a buffer for rendering to the display screen is initiated. Transition parameter data specifying how content of the buffer transitions to the display screen over a period of time is received at step 505. This data may be received with the initial request or at a later time. At step 507, the content of the buffer is rendered to the display screen in accordance to the transition parameter data.

Additional steps, shown in broken line form, may include determining whether new transition parameter data specifying how the content of the buffer transitions to the display over time is received at step 509. If new transition parameter data has been received, the process moves to step 511 where the content of the buffer is rendered to the display screen in accordance to the new transition parameter data. If no new transition parameter data has been received, the process continues to the painting of the next frame of the animation before the process eventually ends. Each frame generates a new paint sequence during which parameters are re-evaluated.

In terms of an illustrative example, a button displayed on-screen may have a continuous transition between different display states. If a user moves her mouse over the button, the button may begin to transition to a highlighted state. If the user then moves her mouse off the button while the transition is still in effect, a new transition may begin to the previous dimmed state, starting from the current point in the pre-existing transition. The result is the appearance of a smooth change in the appearance of the button, even though the change is a result of a combination of different transitions.

In accordance with aspects of the present invention, the API may be implemented as a set of C++ classes. The following is a listing of illustrative classes and their respective illustrative purposes:

CPaintBuffer Class

The CPaintBuffer class implements a single buffer used to perform buffered painting. Aspects of the CPaintBuffer class in accordance with aspects of present invention include many features. The CPaintBuffer class may include:
a. the creation and destruction of buffers of various formats;
b. the creation, setting, and restoring of target clip regions;
c. animated transition creation;
d. destruction, timing, and update semantics;
e. target painting for animated and non-animated update regions;
f. optimized alpha channel operations for 32-bit buffers; and
g. various state and resource accessories.

In illustrative form, to acquire a CPaintBuffer instance, the public API may be:
paintbuffer_handle BeginBufferedPaint (in hdc_Target, in rect_Target, in buffer_format, in paint_params_struct, out hdc)

Where paint_params_struct may include:
flags that control the buffer allocation
clip rectangle to exclude
blend function for 32 bit alpha blending

And buffer_format may be:
screen-compatible bitmap
32-bit device-independent bitmap
top-down 32-bit device-independent bitmap
top-down 1-bit device-independent bitmap

In code form, it may be:

HPAINTBUFFER
BeginBufferedPaint(

HDC hdcTarget,
RECT rcTarget,
BP_BUFFERFORMAT dwFormat,
_{——}in_opt BP_PAINTPARAMS *pPaintParams,
_{——}out HDC *phdc
);

In illustrative form, to return a CPaintBuffer instance, the public API may be:
EndBufferedPaint(in paint_buffer_handle, in flag_update_target)

In code form:

HRESULT
EndBufferedPaint(

HPAINTBUFFER hBufferedPaint,
BOOL fUpdateTarget
);

The CPaintBuffer class exposes a set of access methods that are exposed publicly:

```
interface IPaintBuffer
{
    // Public accessors and helper functions
    virtual HDC GetTargetDC( ) const = 0 ;
    virtual HRESULT GetTargetRect(_{——}out RECT *prc) const = 0 ;
    virtual HDC GetDC( ) const = 0 ;
    virtual HRESULT GetBits(_{——}out RGBQUAD **ppbBuffer, _{——}out int *pcxRow)
const = 0 ;
    virtual HRESULT Clear(_{——}in_opt const RECT *prc) = 0 ;
    virtual HRESULT SetAlpha(_{——}in_opt const RECT *prc, BYTE alpha) = 0 ;
};
Exposed as:
//------------------------------------------------------------------------
```

| | |
|---|---|
| // GetBufferedPaintTargetRect( ) | - Returns the target rectangle specified |
| during BeginBufferedPaint | |
| // | |
| // hBufferedPaint | - handle to buffered paint context |
| // prc | - pointer to receive target rectangle |

```
//------------------------------------------------------------------------
HRESULT
GetBufferedPaintTargetRect(
    HPAINTBUFFER hBufferedPaint,
    _{——}out RECT *prc
    );
//------------------------------------------------------------------------
```

| | |
|---|---|
| // GetBufferedPaintTargetDC( ) | - Returns the target DC specified during |
| BeginBufferedPaint | |
| // | |
| // hBufferedPaint | - handle to buffered paint context |

```
//------------------------------------------------------------------------
HDC
GetBufferedPaintTargetDC(
    HPAINTBUFFER hBufferedPaint
    );
//------------------------------------------------------------------------
```

| | |
|---|---|
| // GetBufferedPaintDC( ) | - Returns the same paint DC returned by |
| BeginBufferedPaint | |
| // | |
| // hBufferedPaint | - handle to buffered paint context |

```
//------------------------------------------------------------------------
HDC
GetBufferedPaintDC(
    HPAINTBUFFER hBufferedPaint
    );
//------------------------------------------------------------------------
```

| | |
|---|---|
| // GetBufferedPaintBits( ) | - Obtains a pointer to the buffer bitmap, if the |
| buffer is a DIB | |
| // | |
| // hBufferedPaint | - handle to buffered paint context |
| // ppbBuffer | - pointer to receive pointer to buffer bitmap |
| pixels | |
| // pcxRow | - pointer to receive width of buffer bitmap, in |
| pixels; | |
| // | this value may not necessarily be equal to the |
| buffer width | |

```
//------------------------------------------------------------------------
HRESULT
GetBufferedPaintBits(
    HPAINTBUFFER hBufferedPaint,
    _{——}out RGBQUAD **ppbBuffer,
    _{——}out int *pcxRow
    );
//------------------------------------------------------------------------
```

| | |
|---|---|
| // BufferedPaintClear( ) | - Clears given rectangle to ARGB = {0, 0, 0, 0} |
| // | |
| // hBufferedPaint | - handle to buffered paint context |
| // prc | - rectangle to clear; NULL specifies entire buffer |

```
//------------------------------------------------------------------------
HRESULT
BufferedPaintClear(
    HPAINTBUFFER hBufferedPaint,
    _{——}in_opt const RECT *prc
    );
//------------------------------------------------------------------------
```

| | |
|---|---|
| // BufferedPaintSetAlpha( ) | - Set alpha to given value in given rectangle |
| // | |
| // hBufferedPaint | - handle to buffered paint context |
| // prc | - rectangle to set alpha in; NULL specifies |
| entire buffer | |
| // alpha | - alpha value to set in the given rectangle |

```
//------------------------------------------------------------------------
HRESULT
BufferedPaintSetAlpha(
    HPAINTBUFFER hBufferedPaint,
    __in_opt const RECT *prc,
    BYTE alpha
    );
```

CPaintBufferAnimation Class

The CPaintBufferAnimation class implements target painting for animated transitions. Aspects of the CPaintBufferAnimation class in accordance with aspects of present invention include many features. The CPaintBufferAnimation class may include the following transition types:
a. linear fade;
b. cubic fade; and
c. sinusoid fade.

In illustrative form, to acquire a CPaintBufferAnimation instance, the public API may be:
animation_buffer_handle BeginBufferedAnimation (in hdc_Target, in rect_Target, in buffer_format, in optional paint_params_struct, in animation_params_struct, out hdc_from, out hdc_to)

Where animation_params_struct may be:
flags
an animation style, such as none, linear, cubic, or sine
rectangle to animate
animation duration

In code:

HANIMATIONBUFFER
BeginBufferedAnimation(

HDC hdcTarget,
RECT rcTarget,
BP_BUFFERFORMAT dwFormat,
_{——}in_opt BP_PAINTPARAMS *pPaintParams,
_{——}in BP_ANIMATIONPARAMS *pAnimationParams,
_{——}out HDC *phdcFrom,
_{——}out HDC *phdcTo
);

In illustrative form, to return a CPaintBuffer instance, the public API may be:
EndBufferedAnimation (in animation_buffer_handle, in flag_update-target)

In code form:

HRESULT
EndBufferedAnimation(

HANIMATIONBUFFER hbpAnimation,
BOOL fUpdateTarget
);

CPaintBufferPool Class

The CPaintBufferPool class implements a pool of buffers used across multiple buffered painting requests. Aspects of the CPaintBufferPool class in accordance with aspects of present invention include many features. The CPaintBufferPool class may include:
a. self-optimizing buffer matching algorithm;
b. ‘Begin/End’ semantics parameter verification;
c. window animation management; and
d. pool optimization.

The CPaintBufferPool is only exposed publicly via APIs that increment and decrement the pool reference count:

//------------------------------------------------------------------------

| | |
|---|---|
| // BufferedPaintInit( ) - | Initialize the Buffered Paint API. |
| // | Should be called prior to BeginBufferedPaint, |
| // | and should have a matching |
| | BufferedPaintUnInit. |

```
//------------------------------------------------------------------------
THEMEAPI
BufferedPaintInit(
    VOID
    );
//------------------------------------------------------------------------
```

| | |
|---|---|
| // BufferedPaintUnInit( ) - | Uninitialize the Buffered Paint API. |
| // | Should be called once for each call to |
| BufferedPaintInit, | |
| // | when calls to BeginBufferedPaint are no |
| | longer |
| needed. | |

```
//------------------------------------------------------------------------
THEMEAPI
BufferedPaintUnInit(
    VOID
    );
```

The CPaintBufferPool class contains the BeginBufferedPaint( ) and BeginAnimation( ) methods, plus a method to stop current animation

CBufferedPaintThreadManager Class

The CBufferedPaintThreadManager class implements management of a thread-width buffer pool. Aspects of the CBufferedPaintThreadManager class in accordance with aspects of present invention include many features. The CBufferedPaintThreadManager class may include:
a. TLS (thread local storage) slot management; and
b. pool creation, destruction, and reference counting.

The CBufferedPaintThreadManager class is not exposed publicly. Its methods are ThreadAddRef( ) and ThreadRelease( ), which correspond to BufferedPaintInit( ) and BufferedPaintUnInit( ) above, and GetThreadPool( ), which retrieves or creates the thread-wide instance of the thread pool:

class CBufferedPaintThreadManager
{
public:

| // Get the global thread manager for this process | |
|---|---|
| static CBufferedPaintThreadManager *Get( ); | |
| CBufferedPaintThreadManager( ); | |
| ˜CBufferedPaintThreadManager( ); | |
| // Public methods for managing the thread's buffer pool | |
| HRESULT | ThreadAddRef( ); |
| HRESULT | ThreadRelease( ); |
| CPaintBufferPool* | GetThreadPool( ); |

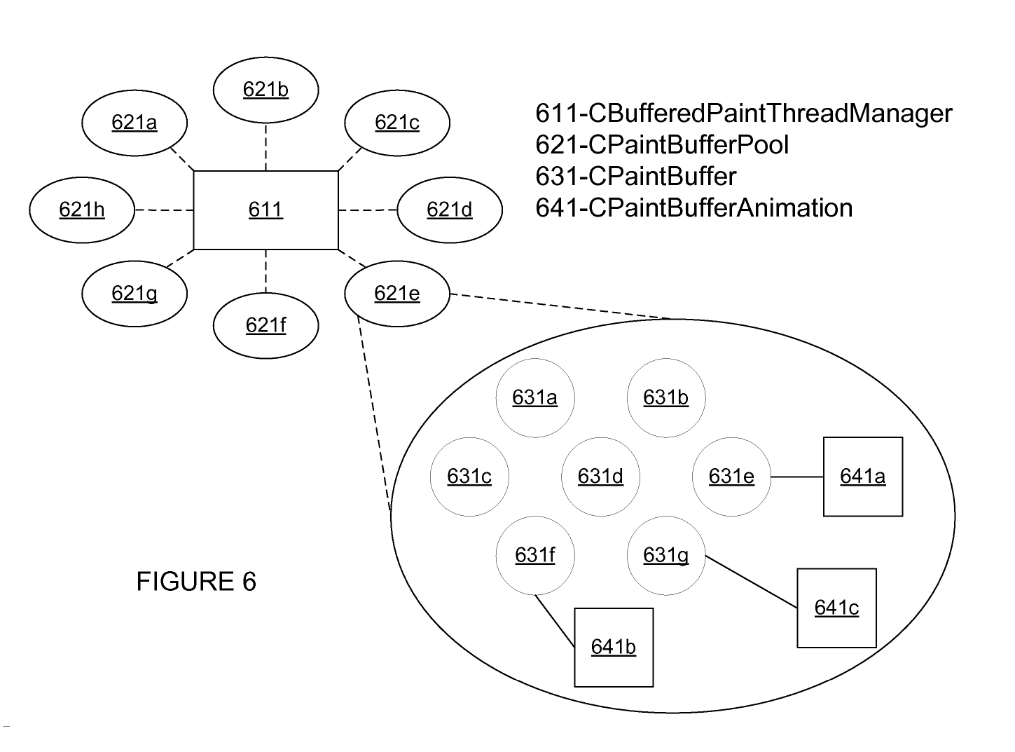

A diagram of the class structure that illustrates the relation between the various classes is shown in FIG. 6.

Each process has a single CBufferedPaintThreadManager instance 611, which manages each process thread and maintains a CPaintBufferPool instance 621a-621h for each thread using the API. Each CPaintBufferPool instance 621 manages any number of CPaintBuffer instances 631. For example, in FIG. 6, CPaintBufferPool instance 621e manages CPaintBuffer instances 631a-631g. In the case where a buffer is undergoing an animated transition, the buffer may make use of a CPaintBufferAnimation instance 641 to perform the animation. In FIG. 6, CPaintBuffer instances 631e, 631f, and 631g, are undergoing an animated transition and make use of CPaintBufferAnimation instances 641a, 641b, and 641c, respectively.

FIG. 7 illustrates a system state when the API in accordance with at least one aspect of the present invention is in use. For each thread, the various components of an application program, 701a-701c for Thread A and 702a-702b for Thread B, make use of the API independently. Internally, the API maintains a pool of buffers for each thread. In FIG. 7, buffers 713a-713d in Pool A are maintained for Thread A and buffers 714a-714b in Pool B are maintained for Thread B. These buffers are transparently shared among the application program components running on that particular thread. When a buffer is not in use, it is kept in memory in order to quickly satisfy future buffer requests. For example, with respect to FIG. 7, buffers 713a-713d may be shared among application program components 701a-701c as needed. It should be understood by those skilled in the art that fewer or more than two threads may be included in accordance with the present invention and that fewer or more than the number of buffers shown and described in the illustrative examples herein may be included and that the present invention is not so limited.

As an illustrative example of an embodiment of one or more aspects of the present invention, the rendering of button controls in a typical user interface may be considered. In a basic approach, each button control is rendered directly to a display screen. Such an approach may result in rendering artifacts such as flashing and tearing as the control buttons are drawn. By adding a few lines of code in accordance with the API of the present invention, the control buttons may be rendered with double-buffering, eliminating these artifacts and enhancing visual quality. By adjusting API transition parameter data, the transition from the buffer to the display screen may be animated, giving visual effects such as fading from a dimmed to a highlighted state when the user moves her mouse over a button. Finally, performance is greatly enhanced. Since each button in the application program's interface uses the API, buffers may be shared among the buttons, significantly reducing memory footprint and processing requirements formerly needed for buffer allocations and deallocations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method for allocating a buffer from a buffer pool, said method comprising:
receiving, from a thread, a request for a buffer from a buffer pool associated with the thread, the buffer pool including a plurality of pre-existing buffers, the request including a type of buffer corresponding to a video buffer;
determining whether a first pre-existing buffer from the buffer pool associated with the thread can be allocated to the thread; and
upon determining that the first pre-existing buffer can be allocated, allocating the first buffer to the thread.

2. The computer-implemented method of claim 1, wherein the request for a buffer is a request for a buffer of a specific size.

3. The computer-implemented method of claim 2, wherein the step of determining includes determining whether the size of the first pre-existing buffer matches the specific size.

4. The computer-implemented method of claim 2, further comprising steps of:
computing the size of each pre-existing buffer from the buffer pool associated with the thread; and
for each pre-existing buffer from the buffer pool, computing a difference in size of the computed size of a pre-existing buffer and the specific size.

5. The computer-implemented method of claim 4, wherein the step of allocating includes allocating the first pre-existing buffer if the difference in size of the first pre-existing buffer is the minimum difference in size compared to each of the other pre-existing buffers from the buffer pool.

6. The computer-implemented method of claim 4, further comprising a step of allocating a pre-existing buffer with a minimum difference in size compared to each of the other pre-existing buffers from the buffer pool.

7. The computer-implemented method of claim 4, further comprising steps of:
comparing a difference in size of a pre-existing buffer with a minimum difference in size compared to each of the other pre-existing buffers from the buffer pool against a threshold limit; and
determining whether the minimum difference in size exceeds the threshold limit.

8. The computer-implemented method of claim 7, wherein the step of allocating includes allocating the first pre-existing buffer if the difference in size of the first pre-existing buffer is the minimum difference in size compared to each of the other pre-existing buffers from the buffer pool and if the minimum difference in size does not exceed the threshold limit.

9. The computer-implemented method of claim 7, further comprising step of:
upon determining that the minimum difference in size exceeds the threshold limit, creating a new buffer to the buffer pool associated with the thread; and
allocating the new buffer to the thread.

10. The computer-implemented method of claim 1, further comprising steps of:
determining whether a second pre-existing buffer from the buffer pool associated with the thread can be allocated to the thread; and
upon determining that the second pre-existing buffer can be allocated, allocating the second pre-existing buffer to the thread.

11. The computer-implemented method of claim 10, further comprising steps of:
determining whether any pre-existing buffer from the buffer pool associated with the thread can be allocated to the thread;
upon determining that no pre-existing buffer can be allocated, creating a new buffer to the buffer pool associated with the thread; and
allocating the new buffer to the thread.

12. A computer-implemented method for performing buffered rendering with animated transitions, said method comprising:
receiving via a first an application programming interface (API) a request to render to a display;
based on the receiving step, initiating a function to obtain a buffer for rendering to the display, the buffer corresponding to a video buffer;
receiving transition parameter data specifying how content of the buffer transitions to the display over a period of time; and
rendering the content of the buffer in accordance to the transition parameter data.

13. The computer-implemented method of claim 12, further comprising a step of determining whether new transition parameter data specifying how the content of the buffer of buffer transitions to the display over time is received.

14. The computer-implemented method of claim 13, wherein upon determining that new transition parameter data has been received, the method further comprising a step of rendering the content of the buffer in accordance to the new transition parameter data.

15. One or more computer-readable media storing a software architecture for processing data representative of a request for a video buffer from a pool of buffers associated with a thread, the pool including a plurality of pre-existing video buffers, the one or more computer-readable media comprising:
at least one component configured to automatically attempt to reuse a pre-existing video buffer from the pool in response to detection of an event for the thread; and
at least one application program interface exposed by the component to access the component.

16. The one or more computer-readable media of claim 15, wherein the at least one component is further configured to compute the size of each pre-existing video buffer from the pool, and, for each pre-existing video buffer from the pool, to compute a difference in size of the computed size of a pre-existing video buffer and a specific size.

17. The one or more computer-readable media of claim 15, wherein the at least one component is further configured to compare a difference in size of a pre-existing video buffer with a minimum difference in size compared to each of the other pre-existing video buffers from the pool against a threshold limit, and to determine whether the minimum difference in size exceeds the threshold limit.

18. The one or more computer-readable media of claim 17, wherein upon determining that the minimum difference in size exceeds the threshold limit, the at least one component is further configured to create a new video buffer to the pool and to allocate the new buffer to the thread.

19. The one or more computer-readable media of claim 18, wherein the at least one component is further configured to destroy at least one of the pre-existing video buffers from the pool.

20. The one or more computer-readable media of claim 15, wherein the at least one component is further configured to receive transition parameter data specifying how content of the pre-existing video buffer transitions to a display over a period of time, and to render the content of the pre-existing video buffer in accordance to the transition parameter data.
